(19) United States
(12) Patent Application Publication
(10) Pub. No.: US 2023/0349561 A1
(43) Pub. Date: Nov. 2, 2023

(54) HEAT DEFLECTION APPARATUS FOR GRILLS

(71) Applicants: Edward Harris, Peace River (CA); Gloria Rondeau-Harris, Peace River (CA)

(72) Inventors: Edward Harris, Peace River (CA); Gloria Rondeau-Harris, Peace River (CA)

(21) Appl. No.: 17/661,343

(22) Filed: Apr. 29, 2022

(51) Int. Cl. F24C 15/36

(52) U.S. Cl. CPC F24C 15/36

(57) ABSTRACT

A heat deflection apparatus that is configured to be secured to a grill wherein the present invention provides deflection of heat and smoke egressing from the rear of the barbeque grill. The present invention includes a frame configured to be secured to the barbeque grill wherein the frame includes lower lateral support members. The frame further includes horizontal support members that are configured to extend outward from the lower lateral support members. Additionally, included in the frame are upper lateral support members that extend upward from the horizontal support members. A shelf support member is superposed the horizontal support members operable to receive tray members thereon. An upper heat shield member is secured to the upper lateral support members and a lower heat shield member is adjacent thereto extending downward therefrom. A void is present intermediate the overlapping edges of the upper heat shield member and lower heat shield member.

### FIELD OF THE INVENTION

The present invention relates generally to barbeque grill accessories, more specifically but not by way of limitation, a heat deflection apparatus that is configured to be secured proximate the rear of a barbeque grill wherein the present invention provides deflection of heat in a first and second direction so as to inhibit the heat from being directed towards a structure that is proximate the barbeque grill.

### BACKGROUND

Millions of individuals routinely cook on outdoor grills also known as barbeque grills. The vast majority of these grills are somewhat portable wherein the grill is installed on a cart that typically provides two wheels so as to facilitate moving of the grill either for inclement weather or to a desired location on a patio or similar area. Conventional grills are operated on mostly two types of fuel which are charcoal and propane. The types of cooking performed on these apparatus ranges from low heat slow cooking to high heat fast cooking. Regardless of the style of cooking, barbeque grills produce a significant amount of heat. As a result of the heat produced this results in an inherent safety risk when utilizing outdoor barbeque grills. Most individuals who live in multi-family residences and have balconies are often prohibited from utilizing grills due to the risks associated therewith.

It is quite common for grills to reach 500° F. or higher during the cooking process. Most often grills are placed in an area where there is overhead protection such as but not limited to a roof eave. As a result of common placement, the grill is often adjacent a wall of the house or structure. Placing the grill adjacent to a wall of a structure presents fire risks as many times the structure may be manufactured from a combustible material such as but not limited to wood. Additionally, for structures that are manufactured from a non-combustible material such as but not limited to brick will have the surface thereof become discolored as a result of the exposure to heat and smoke.

Accordingly, there is a need for a heat deflection apparatus that is mounted to the rear of a barbeque grill wherein the apparatus of the present invention is configured to direct heat and smoke in both an upwards and downwards direction in order to prevent damage to a wall that the barbeque grill is adjacent.

### SUMMARY OF THE INVENTION

It is the object of the present invention to provide a heat deflection apparatus that is configured to be secured to a barbeque grill wherein the present invention includes a frame having lateral lower support members secured to the frame of the barbeque grill.

Another object of the present invention is to provide a grill heat deflection apparatus configured to direct heat and smoke in a first direction and a second direction wherein the present invention includes a shelf support member.

A further object of the present invention is to provide a heat deflection apparatus that is configured to be secured to a barbeque grill wherein the present invention includes a lower heat shield member extending downward.

Still another object of the present invention is to provide a grill heat deflection apparatus configured to direct heat and smoke in a first direction and a second direction that further includes lateral upper support members extending upward from an outer edge of the shelf support member.

An additional object of the present invention is to provide a heat deflection apparatus that is configured to be secured to a barbeque grill wherein the present invention further includes an upper heat shield member extending upward with respect to the shelf support member.

Yet a further object of the present invention is to provide a grill heat deflection apparatus configured to direct heat and smoke in a first direction and a second direction wherein the upper heat shield member and the lower heat shield member are located on opposing sides of the lateral upper support members.

Another object of the present invention is to provide a heat deflection apparatus that is configured to be secured to a barbeque grill wherein the upper heat shield member and lower heat shield member are parallel and have a void therebetween.

An alternate object of the present invention is to provide a grill heat deflection apparatus configured to direct heat and smoke in a first direction and a second direction wherein the present invention can be comprised of aluminum, insulative material and/or a cosmetic finish layer.

Still a further object of the present invention is to provide a heat deflection apparatus that is configured to be secured to a barbeque grill that is adjustable so as to be secured to alternate grill types.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a rear perspective view of the present invention; and

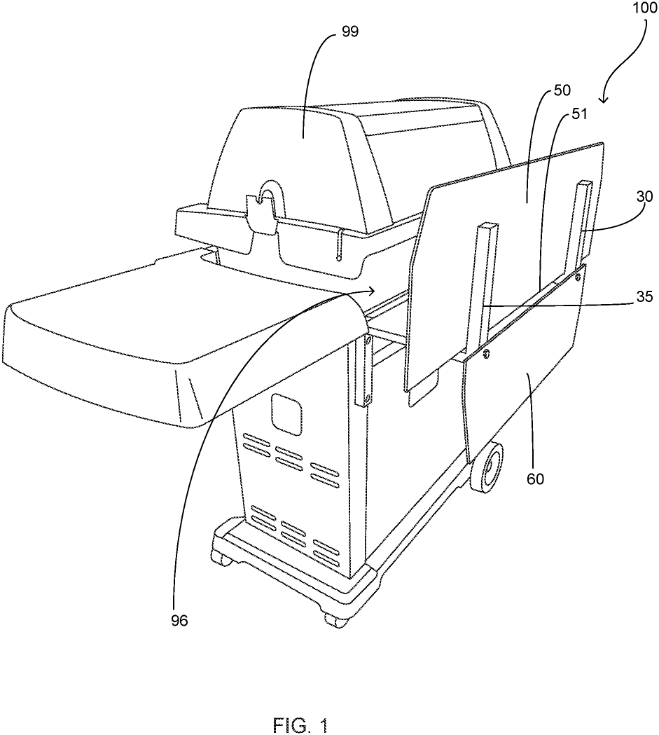

FIG. 2 is a top view of the shelf support member of the present invention; and

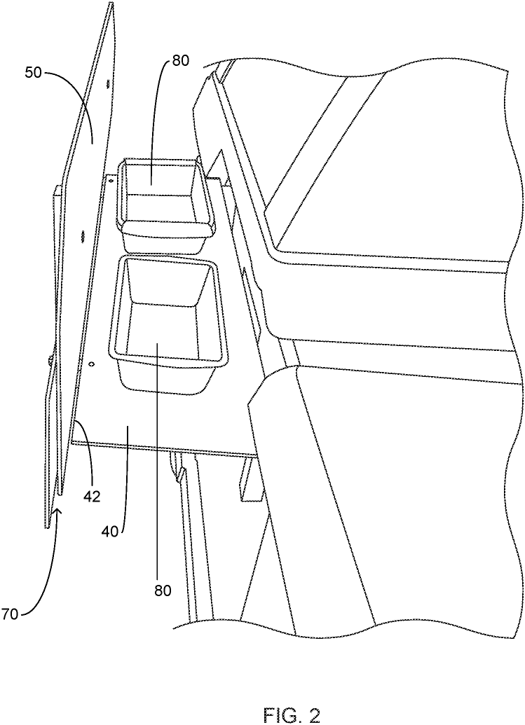

FIG. 3 is an underneath view of the present invention.

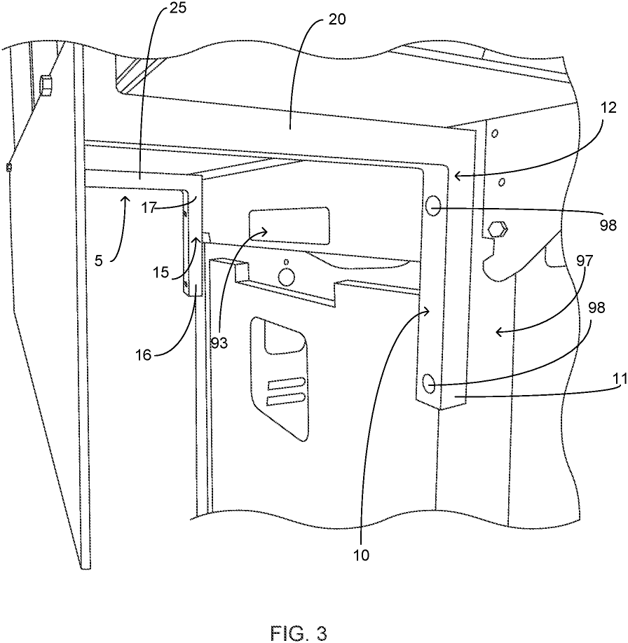

### DETAILED DESCRIPTION

Referring now to the drawings submitted herewith, wherein various elements depicted therein are not necessarily drawn to scale and wherein through the views and figures like elements are referenced with identical reference numerals, there is illustrated a heat deflection apparatus 100 constructed according to the principles of the present invention.

An embodiment of the present invention is discussed herein with reference to the figures submitted herewith. Those skilled in the art will understand that the detailed description herein with respect to these figures is for explanatory purposes and that it is contemplated within the scope of the present invention that alternative embodiments are plausible. By way of example but not by way of limitation, those having skill in the art in light of the present teachings of the present invention will recognize a plurality of alternate and suitable approaches dependent upon the needs of the particular application to implement the functionality of any given detail described herein, beyond that of the particular implementation choices in the embodiment described herein. Various modifications and embodiments are within the scope of the present invention.

It is to be further understood that the present invention is not limited to the particular methodology, materials, uses and applications described herein, as these may vary. Furthermore, it is also to be understood that the terminology used herein is used for the purpose of describing particular embodiments only, and is not intended to limit the scope of the present invention. It must be noted that as used herein and in the claims, the singular forms “a”, “an” and “the” include the plural reference unless the context clearly dictates otherwise. Thus, for example, a reference to “an element” is a reference to one or more elements and includes equivalents thereof known to those skilled in the art. All conjunctions used are to be understood in the most inclusive sense possible. Thus, the word “or” should be understood as having the definition of a logical “or” rather than that of a logical “exclusive or” unless the context clearly necessitates otherwise. Structures described herein are to be understood also to refer to functional equivalents of such structures. Language that may be construed to express approximation should be so understood unless the context clearly dictates otherwise.

References to “one embodiment”, “an embodiment”, “exemplary embodiments”, and the like may indicate that the embodiment(s) of the invention so described may include a particular feature, structure or characteristic, but not every embodiment necessarily includes the particular feature, structure or characteristic.

Referring in particular to the Figures submitted as a part hereof, the heat deflection apparatus 100 includes a frame 5 having a first lower lateral support member 10 and a second lower lateral support member 15. The first lower lateral support member 10 and second lower lateral support member 15 are configured to be secured to a frame or similar structure support the exemplary barbeque grill 99. The first lower lateral support member 10 includes a first end 11 and second end 12. The second lower lateral support member 15 has a first end 16 and a second end 17. The first lower lateral support member 10 and second lower lateral support member 15 are secured via fasteners 98 to the frame 97 of the barbeque grill 99. While in a preferred embodiment the first lower lateral support member 10 and second lower lateral support member 15 are manufactured from square aluminum tubing, it is contemplated within the scope of the present invention that the first lower lateral support member 10 and second lower lateral support member 15 could be manufactured from alternate suitable materials.

Secured to the second end 12 of the first lower lateral support member 10 is the first horizontal support member 20. The first horizontal support member 20 is perpendicular to the first lower lateral support member 10 and configured to extend outward from the barbeque grill 99. Similarly, a second horizontal support member 25 is secured to the second lower lateral support member 15 and perpendicular thereto extending outward away from the barbeque grill 99. Contiguously formed with the first horizontal support member 20 distal to the first lower lateral support member 10 is the first upper lateral support member 30. The first upper lateral support member 30 is perpendicular to the first horizontal support member 20 and configured to extend upward therefrom. A second upper lateral support member 35 is present and is contiguously formed with the second horizontal support member 25 distal to the second lower lateral support member 15. The second upper lateral support member 35 is perpendicular to the second horizontal support member 25 and extends upward therefrom. It should be understood within the scope of the present invention that the frame 5 could be configured in alternate manners in order to provide a structure to secure the heat deflection apparatus 100 to a barbeque grill 99.

The first horizontal support member 20 and second horizontal support member 25 extend away from the barbeque grill 99 a sufficient distance so as to provide space for the shelf support member 40. The shelf support member 40 is planar in manner and superposed the first horizontal support member 20 and second horizontal support member 25 being secured thereto utilizing suitable mechanical or chemical techniques. The shelf support member 40 provides a space to receive thereon trays 80 wherein the trays 80 can be utilized to place food therein to maintain at a temperature above that of ambient. It should be understood within the scope of the present invention that the trays 80 could be either integrally formed into the shelf support member 40 or configured to be placed thereon.

The heat deflection apparatus 100 includes an upper heat shield member 50. The upper heat shield member 50 is manufactured from a durable material such as but not limited to aluminum. The upper heat shield member 50 has a lower edge 51 proximate the second edge 42 of the shelf support member 40. The upper heat shield member 50 extends upward from the shelf support member 40 and is secured to the first upper lateral support member 30 and the second upper lateral support member 35 utilizing suitable mechanical techniques. The upper heat shield member 50 functions to direct the heat and smoke exiting area 96 in an upwards direction. In a preferred embodiment the upper heat shield member 50 is manufactured to a width that is generally equivalent to the width of the shelf support member 40.

The heat deflection apparatus 100 further includes a lower heat shield member 60. The lower heat shield member 60 is secured to the first upper lateral support member 30 and the second upper lateral support member 35, particularly the lower ends thereof, utilizing suitable durable mechanical techniques. The lower heat shield member 60 is planar in manner being manufactured from a material such as but not limited to aluminum. The lower heat shield member 60 extends downward and is operable to divert heat and smoke from area 93. It should be understood within the scope of the present invention that the upper heat shield member 50 and lower heat shield member 60 could be provided in alternate sizes and shapes. The upper heat shield member 50 and lower heat shield member 60 are secured to opposing sides of the first upper lateral support member 30 and the second upper lateral support member 35 so as to create void 70 therebetween. Void 70 facilitates airflow between the lower heat shield 60 and upper heat shield member 50 so as to assist in the dissipation of heat being generated from the barbeque grill 99.

It should be understood within the scope of the present invention that the upper heat shield member 50 and lower heat shield member 60 could be manufactured utilizing alternate materials or a combination of materials. By way of example but not limitation, the upper heat shield member 50 and lower heat shield member 60 could include insulative layers being further capped with decorative layers of various materials. Additionally, while an upper heat shield member 50 and lower heat shield member 60 are illustrated and discussed herein, it is contemplated within the scope of the present invention that the heat deflection apparatus 100 could be provided with only one heat shield member. Furthermore, while not particularly illustrated herein, it should be understood that the heat deflection apparatus 100 could be provided so as to be adjustable both in height and width in order to be mounted to barbeque grills 99 of various sizes.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A heat deflection apparatus configured to be secured to a barbeque grill and provide deflection of smoke and heat egressing from a rear thereof wherein the heat deflection apparatus comprises:
a frame, said frame being configured to be secured to the barbeque grill, said frame being secured to the rear of the barbeque grill; and
at least one heat shield member, wherein said at least on heat shield member is secured to the frame distal to the barbeque grill, said at least one heat shield member being planar in manner, said at least one heat shield member being generally perpendicular to the barbeque grill, wherein said at least one heat shield member is configured to direct heat and smoke egressing from the barbeque grill in a first direction and a second direction.

2. The heat deflection apparatus configured to be secured to a barbeque grill as recited in claim 1, and further including a shelf support member, said shelf support member being secured to said frame, said shelf support member being adjacent the rear of the barbeque grill, said shelf support member having an upper surface.

3. The heat deflection apparatus configured to be secured to a barbeque grill as recited in claim 2, and further including at least one tray, said at least one tray being configured to receive and store food therein, said at least one tray being superposed the upper surface of said shelf support member.

4. The heat deflection apparatus configured to be secured to a barbeque grill as recited in claim 3, wherein said at least one heat shield member includes a layer of metal and a layer of insulative material.

5. The heat deflection apparatus configured to be secured to a barbeque grill as recited in claim 4, wherein the heat deflection apparatus is adjustable in height with respect to the barbeque grill.

6. A heat deflection apparatus configured to be secured to a barbeque grill and provide deflection of smoke and heat in a first direction and a second direction wherein the heat deflection apparatus comprises:
a frame, said frame having a first lower lateral support member and a second lower lateral support member, said first lower lateral support member and said second lower lateral support member being secured to a frame of the barbeque grill, said first lower lateral support member and said second lower lateral support member being parallel, said first lower lateral support member and said second lower lateral support member having lower ends and upper ends, said frame further including a first horizontal support member and a second horizontal support member, said first horizontal support member being contiguously formed with said first lower lateral support member, said first horizontal support member being perpendicular to said first lower lateral support member extending away from the barbeque grill, said second horizontal support member being contiguous with said second lower lateral support member, said second horizontal support member being perpendicular to said second lower lateral support member and extending away from the barbeque grill, said second horizontal support member being parallel with said first horizontal support member, said frame further including a first upper lateral support member, said first lateral upper support member being contiguous with said first horizontal support member distal to said first lower lateral support member, said first upper lateral support member extending upward from said first horizontal support member, said frame further including a second upper lateral support member, said second lateral upper support member being contiguous with said second horizontal support member distal to said second lower lateral support member, said second upper lateral support member extending upward from said second horizontal support member; and
an upper heat shield member, said upper heat shield member being planar in manner, said upper heat shield member having an upper edge and a lower edge, said upper heat shield member being secure to said first upper lateral support member and said second upper lateral support member, said upper heat shield member being perpendicular to the barbeque grill.

7. The heat deflection apparatus configured to be secured to a barbeque grill and provide deflection of smoke and heat in a first direction and a second direction as recited in claim 6, wherein said first upper lateral support member and said second upper lateral support member include an inner side and an outer side wherein said inner side is proximate the barbeque grill.

8. The heat deflection apparatus configured to be secured to a barbeque grill and provide deflection of smoke and heat in a first direction and a second direction as recited in claim 7, and further including a lower heat shield member, said lower heat shield member being planar in manner, said lower heat shield member being secured to said first upper lateral support member and said second upper lateral support member and extending downward therefrom, said lower heat shield member being secured to the outer side of the first upper lateral support member and said second upper lateral support member.

9. The heat deflection apparatus configured to be secured to a barbeque grill and provide deflection of smoke and heat in a first direction and a second direction as recited in claim 8, wherein said upper heat shield member is secured to the inner side of the first upper lateral support member and said second upper lateral support member.

10. The heat deflection apparatus configured to be secured to a barbeque grill and provide deflection of smoke and heat in a first direction and a second direction as recited in claim 9, wherein a void is present between said upper heat shield member and said lower heat shield member.

11. The heat deflection apparatus configured to be secured to a barbeque grill and provide deflection of smoke and heat in a first direction and a second direction as recited in claim 10, and further including a shelf support member, said shelf support member being superposed the first horizontal support member and the second horizontal support member, said shelf support member being planar in manner and configured to receive a tray on an upper surface thereof.

12. The heat deflection apparatus configured to be secured to a barbeque grill and provide deflection of smoke and heat in a first direction and a second direction as recited in claim 11, wherein said upper heat shield member and said lower heat shield.
